(19) United States
(12) Patent Application Publication
(10) Pub. No.: US 2022/0048816 A1
(43) Pub. Date: Feb. 17, 2022

(54) Screen Protector Installation Tool

(71) Applicant: NLU Products, L.L.C., Lehi, UT (US)

(72) Inventor: RYAN HUNTER HOFSTRAND, Saratoga Springs, UT (US)

(21) Appl. No.: 17/400,816

(22) Filed: Aug. 12, 2021

Related U.S. Application Data
(60) Provisional application No. 63/064,693, filed on Aug. 12, 2020.

(51) Int. Cl. C03C 27/06

(52) U.S. Cl. CPC C03C 27/06

(57) ABSTRACT

A mobile device screen protector installation system includes a screen protector and a screen protector application tool. The screen protector application tool has a width extending from a first side to a second side, and a passageway extending from the first side to the second side. The screen protector application tool includes a first device alignment profile on the first side and a second device alignment profile on the second side. The first device alignment profile has a different shape than the second device alignment profile.

### RELATED APPLICATIONS

This application claims the benefit of U.S. Provisional Patent Application No. 63/064,693, filed Aug. 12, 2020, which is incorporated herein by reference.

### FIELD OF THE DISCLOSURE

This disclosure is generally related to the field of screen protectors for mobile devices and, in particular, to an applicator device for screen protectors.

### BACKGROUND

As mobile devices, such as cell phones, tablets, and other carriable electronic devices become more predominant worldwide, the amount of waste associated with such mobile devices, and their accessories, may also increase. For example, screen protectors may be used to protect the display of a mobile device from damage. Screen protectors are most frequently formed of a thin polymer film with an adhesive backing, although recent products also offer thin glass protectors. The film is oriented on the screen and provides additional protection of the native screen from damage such as scratches and impact fractures. Unfortunately, most screen protectors are fixed in place once contacted with the native screen. Careful orientation and installation are desirable to avoid misplaced screen protectors. Accordingly, misapplication of a screen protector may result in waste.

In order to install screen protectors, applicators have been developed which enable a user to quickly and accurate align a screen protector with the screen of a mobile device. An example of a screen protector applicator is shown in U.S. Pat. No. 10,076,872 to NLU Products LLC, which is incorporated herein by reference. Some disadvantages of known screen protector applicators are that they 1) may not be reused and/or 2) are specific to a single device model. Screen protector applicators that are not device model specific may provide inferior placement compared to model specific applicators. Other disadvantages of known screen protector applicators may exist.

### SUMMARY

An embodiment of a mobile device screen protector installation system includes screen protector application tool. The screen protector application tool has a base with a first side, a second side, and a passageway extending from the first side to the second side. The first side includes a first device alignment profile. The second side includes a second device alignment profile. The first device alignment profile is shaped complimentary to a frame of a first mobile device. The second device alignment profile is shaped complimentary to a frame of a second mobile device that is different from the frame of the first mobile device.

The mobile device screen protector installation system may include a screen protector sized to be received within the passageway. The mobile device screen protector installation system may include instructions for applying the screen protector to a screen of a mobile device. The instructions specify placing the screen protector application tool over the mobile device corresponding to one of the first device alignment profile and the second device alignment profile. The instructions may include placing the screen protector onto the screen of the mobile device through the passageway.

The base may include a width extending from the first side to the second side. The base may include a first wall extending along the width on the first side. The first wall forms at least a portion of the first device alignment profile. The base may include a second wall extending along the width on the second side. The second wall forms at least a portion of the second device alignment profile.

The base may include an alignment ridge. The alignment ridge extends inward from the base and defines the passageway. The passageway may have an area of at least 90% of an area bounded by the first wall. The passageway may have an area of at least 95% of an area bounded by the first wall.

The base may include a transition between the first wall and the alignment ridge that is curved. The first device alignment profile may include one or more recesses positioned to accommodate features on the frame of the first mobile device. The first device alignment profile may be larger than the second device alignment profile.

An embodiment of a mobile device screen protector installation system includes a screen protector and a screen protector application tool. The screen protector application tool has a width extending from a first side to a second side, and a passageway extending from the first side to the second side. The passageway is large enough to permit the screen protector to pass through the width of the screen protector application tool. The screen protector application tool includes a first device alignment profile on the first side and a second device alignment profile on the second side. The first device alignment profile has a different shape than the second device alignment profile.

An embodiment of a method of applying a mobile device screen protector includes placing a screen protector application tool over a first mobile device. The screen protector application tool includes a first device alignment profile on a first side, a second device alignment profile on a second side, and a passageway extending from the first side to the second side. The first device alignment profile retains the screen protector application tool on the first mobile device when the screen protector application tool is placed over the first mobile device. The method includes applying a first screen protector to a screen of the first mobile device through the passageway. The first screen protector may be a glass screen protector.

The method may include placing the screen protector application tool over a second mobile device. The second device alignment profile retains the screen protector application tool on the second mobile device. The method may include applying a second screen protector to the second mobile device through the passageway.

The first screen protector may include a flexible applicator film. The method may include placing the first screen protector in contact with the screen of the first mobile device, wherein the flexible applicator film is positioned on a side of the first screen protector opposite of the screen of the first mobile device. The method may include removing the screen protector application tool off of the first mobile device while the first screen protector is in contact with the screen of the first mobile device. The method may include removing the flexible applicator film from the first screen protector after the screen protector application tool has been removed off of the first mobile device.

The first mobile device and the second mobile device may be made by different manufacturers. The first device alignment profile may be larger than the second device alignment profile. The first device alignment profile may include one or more recesses and the method may include aligning buttons on a frame of the first mobile device with the one or more recesses.

The screen protector application tool may include a width extending from the first side to the second side. The first device alignment profile may include an alignment ridge extending inward non-parallel to the width. The method may include aligning the first mobile device such that the alignment ridge on the first side is complementary to a front portion of a frame of the first mobile device.

The method may include placing the front portion of the frame of the first mobile device in contact with the alignment ridge on the first side of the screen protector application tool. The screen protector application tool may include a first wall extending along the width on the first side of the screen protector application tool. The method may include aligning the first mobile device such that a perimeter of the frame of the first mobile device is complementary with the first wall. Other embodiments are also disclosed.

### BRIEF DESCRIPTION OF THE DRAWINGS

FIG. 1 is a schematic view of a screen protector application tool aligned with two separate mobile devices.

FIG. 2 and FIG. 3 are, respectively, perspective top and bottom views of an embodiment of a screen protector application tool.

FIG. 4 represents an installation guide illustrating an installation process using an embodiment of a screen protector application tool.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the scope of the invention as defined by the appended claims.

### DETAILED DESCRIPTION

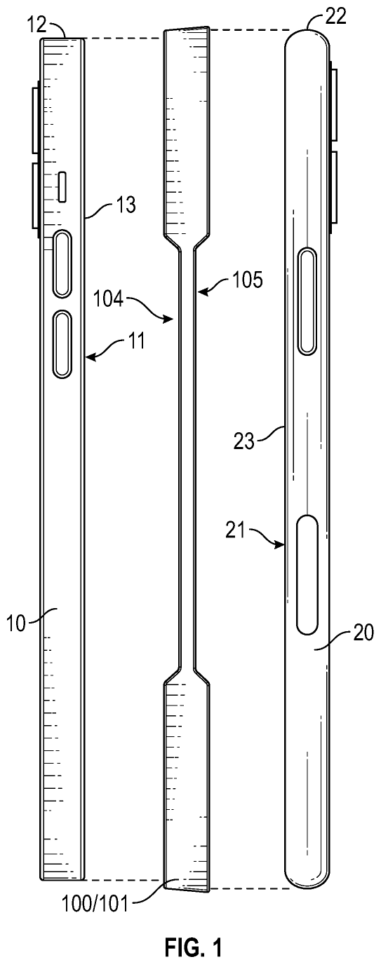

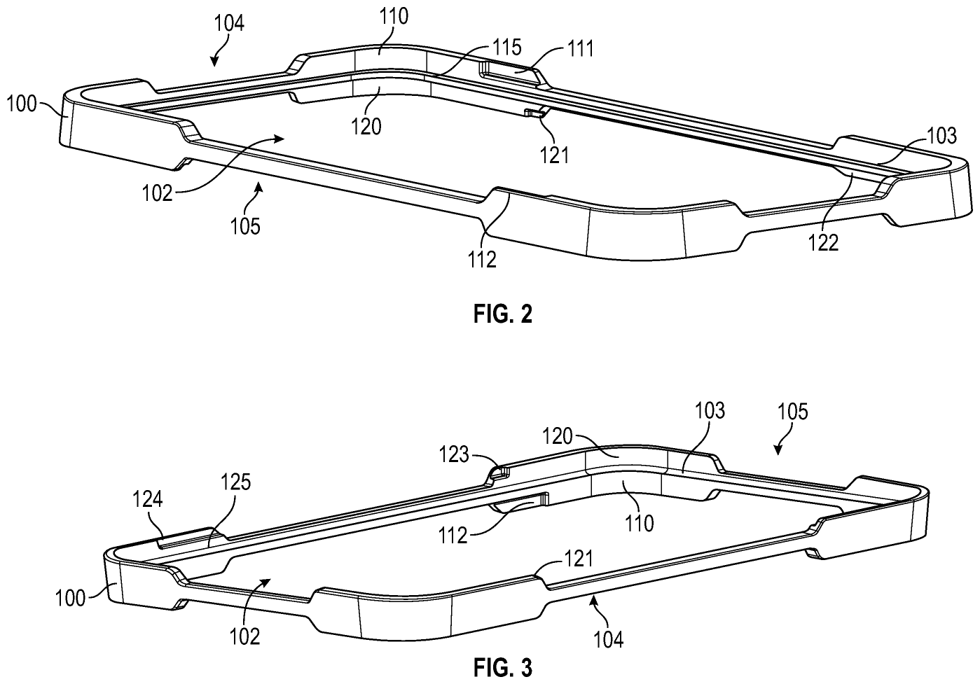

Referring to FIG. 1, an embodiment of a screen protector application tool 100 is shown aligned with each of a first mobile device 10 and a second mobile device 20. A frame 12 of the first mobile device 10 has a different shape than a frame 22 of the second mobile device 20. The frames 12, 22 extend around the perimeter of their respective mobile devices 10, 20. The frame 12 of the first mobile device 10 includes a front portion 13 located on a side of the mobile device 10 that includes a screen 11. The frame 22 of the second mobile device 20 includes a front portion 23 located on a side of the mobile device 20 that includes a screen 21. In some embodiments, the first mobile device 10 and the second mobile device 20 may be made by different manufacturers, such as Apple Inc. and Samsung Electronics. In some embodiments, the first mobile device 10 and the second mobile device 20 may be made by the same manufacturer but have different shaped frames and/or screen sizes. The screen protector application tool 100 permits the same applicator tool to be used to install a screen protector (not shown in FIG. 1) on two different mobile devices 10, 20. The screen protector application tool 100 includes a base 101 having a first side 104 and a second side 105. The first side 104 of the screen protector installation tool 100 is shaped to fit the first mobile device 10. When the frame 12 of the first mobile device 10 is positioned by the first side 104 of the screen protector application tool 100, the screen 11 of the first mobile device 10 may be accessed from the second side 105 through a passageway 102 (shown in FIGS. 2 and 3) in the screen protector application tool 100. The second side 105 of the screen protector installation tool 100 is shaped to fit the second mobile device 20. When the frame 22 of the second mobile device 20 is positioned by the second side 105 of the screen protector application tool 100, the screen 21 of the second mobile device 20 may be accessed from the first side 104 through the passageway 102 (shown in FIGS. 2 and 3) in the screen protector application tool 100. This permits a single screen protector installation tool 100 to be used for two mobile devices 10, 20 that would have required separate specific installation tools previously.

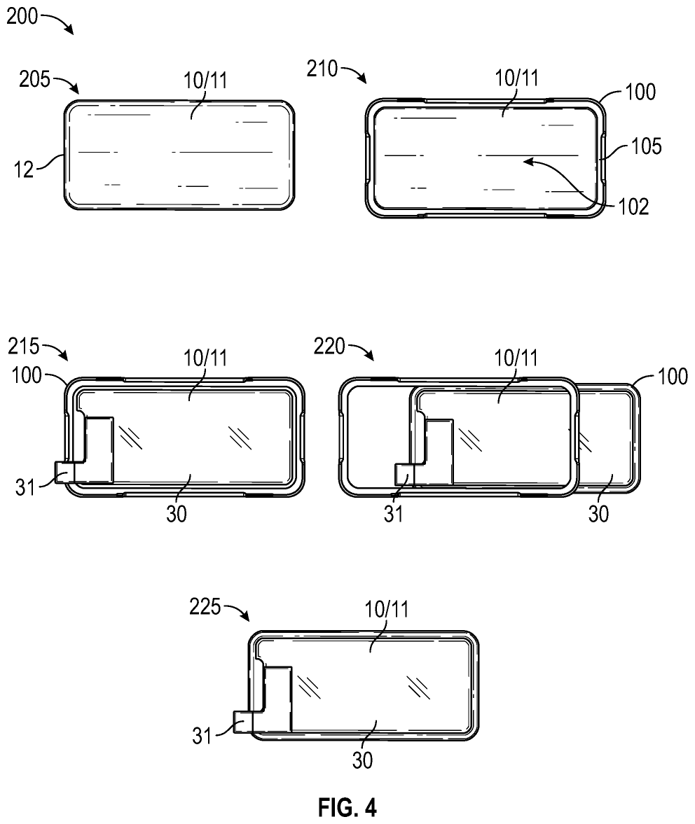

FIGS. 2 and 3 are perspective top and bottom views of the screen protector application tool 100. The base 101 has a width extending from the first side 104 to the second side 105. The base 101 has walls forming a first wall 110 on the first side 104 and forming a second wall 120 on the second side 105. The first wall 110 extends along the width of the base 101 on the first side 104 of the base 101 and the second wall 120 extends along the width of the base 101 on the second side 105 of the base 101. The base 101 includes an alignment ridge 103 extending inward with respect to the first wall 110 and the second wall 120. In other words, the alignment ridge 103 is oriented non-parallel to the width of the base 101. In some embodiments, it may be beneficial to minimize the size of the alignment ridge 103 to maximize the size of the passageway 102 and the corresponding screen protector 30 (shown in FIG. 4) that may be received through the passageway 102. The size of the screen protector 30 may be substantially the same as the size of the passageway 102, such that the screen protector 30 covers most of the screen of the mobile device when installed. In some embodiments, the size of the passageway 102 may have an area of at least 90% of an area bounded by the first wall 110 and, preferably, at least 95% of an area bounded by the first wall 110.

In some embodiments, a transition between the walls of the base 101 (first wall 110 and second wall 120) and the alignment ridge 103 may be curved to complement the shape of the mobile device for which screen protector application tool 100 is used. The alignment ridge 103 defines the passageway 102 shaped to receive a screen protector for application to a mobile device. The passageway 102 extends from the first side 104 to the second side 105. The alignment ridge 103 on the first side 104 and the first wall 110 form a first device alignment profile 115. The first device alignment profile 115 is shaped to receive the screen side of the first mobile device 10. When the first mobile device 10 is received within first device alignment profile 115, the first mobile device 10 is aligned such that the perimeter of the frame 12 of first mobile device 10 is complementary with the first wall 110 and the front portion 13 of the frame 12 is complementary with the alignment ridge 103 on the first side 104. In some embodiments, the first wall 110 may contact the perimeter of the frame 12 of first mobile device 10. In some embodiments, the front portion 13 of the frame 12 may contact the alignment ridge 103 on the first side 104. In some embodiments, the screen protector application tool 100 may extend around only a portion of the perimeter of the frame of the mobile device, such as around half of the frame of the mobile device.

The first device alignment profile 115 is shaped complimentary to the frame 12 of the first mobile device 10, such that the first mobile device 10 is retained by the screen protector application tool 100 when received within the first device alignment profile 115. For example, a distance between the first wall 110 and the frame 12 of the first mobile device may be less than 2 mm. In another embodiment, the distance is less than 1 mm. In yet another embodiment, the distance is less than 0.5 mm.

The alignment ridge 103 on the second side 105 and the second wall 120 form a second device alignment profile 125. The second device alignment profile 125 is shaped to receive the screen side of the second mobile device 20. The second device alignment profile 125 is shaped complimentary to the frame 22 of the second mobile device 20, such that the second mobile device 20 is retained by the screen protector application tool 100 when received within the second device alignment profile 125. The first device alignment profile 115 is not shaped complimentary to the frame 22 of the second mobile device 20 and the second device alignment profile 125 is not shaped complimentary to the frame 12 of the first mobile device 10. In some embodiments, the first device alignment profile 115 may be larger than the second device alignment profile 125.

The first device alignment profile 115 may include one or more recesses 111, 112 positioned to accommodate features on the frame 12 of the first mobile device 10, such as a power button and volume buttons. The second device alignment profile 125 may include one or more recesses 121, 122, 123, 124 positioned to accommodate features on the frame 22 of the second mobile device 20, such as a power button and volume buttons.

FIG. 4 represents an installation guide 200 illustrating an installation process using an embodiment of the screen protector application tool 100. In Action 205, the first mobile device 10 may be initially placed on a surface with the screen 11 pointing upward. The frame 12 of first mobile device 10 is exposed. Next, in Action 210, the screen protector application tool 100 is placed over the first mobile device 10 such that first device alignment profile 115 is aligned with frame 12 of first mobile device 10 and the second side 105 is facing upward, away from first mobile device 10. As a result, the passageway 102 is positioned above screen 11 of first mobile device 10. With the screen protector application tool 100 placed over the first mobile device 10, a screen protector 30 is placed within screen protector application tool 100 from the second side 105 through the passageway 102 in Action 215. A user may reach through the second side 105 of the screen protector application tool 100 and press the screen protector 30 into contact with the screen 11 of the first mobile device 10 in order to adhere the screen protector 30 to the first mobile device 10. The screen protector 30 may be a glass screen protector.

In some embodiments, screen protector 30 may be placed directly in contact with screen 11 as the screen protector 30 passes through the passageway 102. In other embodiments, a flexible applicator film 31 for the screen protector 30 may contact the screen protector application tool 100 and suspend the screen protector 30 above the screen 11 until a user presses downward upon the screen protector 30 to place it in contact with the screen 11. With the screen protector 30 in contact with the screen 11 of first mobile device 10, the screen protector application tool 100 is removed in Action 220 and the screen protector 30 remains in contact with the screen 11. Next, in Action 225, flexible applicator film 31 for screen protector 30 may be removed.

In some embodiments, Actions 200-225 may then be repeated using the second device alignment profile 125 on the second device 20, as would be appreciated by a person skilled in the art having the benefit of this disclosure. In particular, a user may place screen protector application tool 100 over the second mobile device 20 such that the second device alignment profile 125 is aligned with frame 22 of the second mobile device 20 and the first side 104 of the screen protector application tool 100 is facing upward.

With the screen protector application tool 100 placed over the second mobile device 20, a screen protector is placed within the screen protector application tool 100 from the first side 104 through passageway 102. A user may reach through the first side 104 of the screen protector application tool 100 and press the screen protector into contact with the screen 21 of the second mobile device 20 in order to adhere the screen protector to the second mobile device 20. With the screen protector in contact with the screen 21 of the second mobile device 20, the screen protector application tool 100 is removed and the flexible applicator film for the screen protector may be removed.

Although this disclosure has been described in terms of certain preferred embodiments, other embodiments that are apparent to those of ordinary skill in the art, including embodiments that do not provide all of the features and advantages set forth herein, are also within the scope of this disclosure. Accordingly, the scope of the present disclosure is defined only by reference to the appended claims and equivalents thereof.

What is claimed is:

1. A mobile device screen protector installation system, comprising:
a screen protector application tool having a base with a first side, a second side, and a passageway extending from the first side to the second side, the first side including a first device alignment profile, the second side including a second device alignment profile, the first device alignment profile being shaped complimentary to a frame of a first mobile device, the second device alignment profile being shaped complimentary to a frame of a second mobile device that is different from the frame of the first mobile device.

2. The mobile device screen protector installation system of claim 1, further comprising a screen protector sized to be received within the passageway.

3. The mobile device screen protector installation system of claim 2, further comprising instructions for applying the screen protector to a screen of a mobile device, wherein the instructions specify placing the screen protector application tool over the mobile device corresponding to one of the first device alignment profile and the second device alignment profile, and placing the screen protector onto the screen of the mobile device through the passageway.

4. The mobile device screen protector installation system of claim 1, wherein the base further comprises a width extending from the first side to the second side, a first wall extending along the width on the first side, and a second wall extending along the width on the second side, the first wall forming at least a portion of the first device alignment profile, the second wall forming at least a portion of the second device alignment profile.

5. The mobile device screen protector installation system of claim 4, wherein the base further comprises an alignment ridge, the alignment ridge extends inward from the base, wherein the alignment ridge defines the passageway.

6. The mobile device screen protector installation system of claim 5, wherein the passageway has an area of at least 90% of an area bounded by the first wall.

7. The mobile device screen protector installation system of claim 5, wherein the passageway has an area of at least 95% of an area bounded by the first wall.

8. The mobile device screen protector installation system of claim 5, wherein the base includes a transition between the first wall and the alignment ridge that is curved.

9. The mobile device screen protector installation system of claim 1, wherein the first device alignment profile includes one or more recesses positioned to accommodate features on the frame of the first mobile device.

10. The mobile device screen protector installation system of claim 1, wherein the first device alignment profile is larger than the second device alignment profile.

11. A mobile device screen protector installation system, comprising:
a screen protector; and
a screen protector application tool having a width extending from a first side to a second side, a passageway extending from the first side to the second side, the passageway being large enough to permit the screen protector to pass through the width of the screen protector application tool, a first device alignment profile on the first side, and a second device alignment profile on the second side, wherein the first device alignment profile has a different shape than the second device alignment profile.

12. A method of applying a mobile device screen protector, comprising:
placing a screen protector application tool over a first mobile device, the screen protector application tool including a first device alignment profile on a first side, a second device alignment profile on a second side, and a passageway extending from the first side to the second side, the first device alignment profile retaining the screen protector application tool on the first mobile device when the screen protector application tool is placed over the first mobile device; and
applying a first screen protector to a screen of the first mobile device through the passageway.

13. The method of applying a mobile device screen protector of claim 12, wherein the first screen protector includes a flexible applicator film and the method further comprises:
placing the first screen protector in contact with the screen of the first mobile device, the flexible applicator film being positioned on a side of the first screen protector opposite of the screen of the first mobile device;
removing the screen protector application tool off of the first mobile device while the first screen protector is in contact with the screen of the first mobile device; and
removing the flexible applicator film from the first screen protector after the screen protector application tool has been removed off of the first mobile device.

14. The method of applying a mobile device screen protector of claim 12, wherein the first screen protector is a glass screen protector.

15. The method of applying a mobile device screen protector of claim 12, wherein the first device alignment profile includes one or more recesses and the method further comprises aligning buttons on a frame of the first mobile device with the one or more recesses.

16. The method of applying a mobile device screen protector of claim 12, further comprising:
placing the screen protector application tool over a second mobile device, the second device alignment profile retaining the screen protector application tool on the second mobile device; and
applying a second screen protector to the second mobile device through the passageway.

17. The method of applying a mobile device screen protector of claim 16, wherein the first mobile device and the second mobile device were made by different manufacturers.

18. The method of applying a mobile device screen protector of claim 12, wherein the screen protector application tool includes a width extending from the first side to the second side, the first device alignment profile includes an alignment ridge extending inward non-parallel to the width, and the method further comprises aligning the first mobile device such that the alignment ridge on the first side is complementary to a front portion of a frame of the first mobile device.

19. The method of applying a mobile device screen protector of claim 18, wherein aligning the first mobile device such that the alignment ridge on the first side of the screen protector application tool is complementary to a front portion of the frame of the first mobile device comprises placing the front portion of the frame of the first mobile device in contact with the alignment ridge on the first side of the screen protector application tool.

20. The method of applying a mobile device screen protector of claim 18, wherein the screen protector application tool includes a first wall extending along the width on the first side of the screen protector application tool and the method further comprises aligning the first mobile device such that a perimeter of the frame of the first mobile device is complementary with the first wall.
